(19) United States
(12) Patent Application Publication
(10) Pub. No.: US 2024/0104163 A1
(43) Pub. Date: Mar. 28, 2024

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Makoto Takamoto, Tokyo (JP)

(73) Assignee: NEC Corporation, Minato-ku, Tokyo (JP)

(21) Appl. No.: 18/274,854

(22) PCT Filed: Dec. 17, 2021
(86) PCT No.: PCT/JP2021/046803

§ 371 Date: Jul. 28, 2023

(30) Foreign Application Priority Data
Mar. 30, 2021 (JP) 2021-057842

(51) Int. Cl. G06F 17/15; G06F 17/14

(52) U.S. Cl. CPC G06F 17/15; G06F 17/148

(57) ABSTRACT

An information processing system includes: an input unit that inputs a feature quantity; a transform unit that performs a discrete wavelet transform on the feature quantity; a decomposition unit that decomposes a result of the discrete wavelet transform into a first frequency component and a second frequency component; a first processing unit that performs a convolution process on the first frequency component; a second processing unit that performs a convolution process on the second frequency component; an integration unit that integrates a result of the convolution process for the first frequency component and a result of the convolution process for the second frequency component, thereby to generate an integrated information; and an output unit that outputs the integrated information.

### TECHNICAL FIELD

This disclosure relates to technical fields of an information processing system, an information processing method, and a recording medium that process information used for deep learning, for example.

### BACKGROUND ART

A known system of this type transforms information by using a wavelet transform. For example, Patent Literature 1 discloses that a discrete wavelet transform is used as a band-pass filter of an imaging process. Patent Literature 2 discloses that a frame image is decomposed into two-dimensional frequency components by performing a discrete wavelet decomposition in a horizontal direction and a vertical direction. Patent Literature 3 discloses that a wavelet transform is applied to image data, thereby to obtain image data representing an image for each of a plurality of frequency bands.

As another related technique/technology, for example, Patent Literature 4 discloses that projection data are divided into a high-frequency component and a low-frequency component in the learning of a DL-ANN network. Patent Literature 5 discloses that learning is performed by integrating outputs from a plurality of partial neural networks.

### CITATION LIST

### Patent Literature

Patent Literature 1: International Publication No. WO2019/172262

Patent Literature 2: JP2011-004343A

Patent Literature 3: JPH11-272867A

Patent Literature 4: JP2020-099662A

Patent Literature 5: JP2020-030480A

### SUMMARY

### Technical Problem

This disclosure aims at the disclosures of the Patent Literatures in Cited List.

### Solution to Problem

An information processing system according to an example aspect of this disclosure includes: an input unit that inputs a feature quantity; a transform unit that performs a discrete wavelet transform on the feature quantity; a decomposition unit that decomposes a result of the discrete wavelet transform into a first frequency component and a second frequency component; a first processing unit that performs a convolution process on the first frequency component; a second processing unit that performs a convolution process on the second frequency component; an integration unit that integrates a result of the convolution process for the first frequency component and a result of the convolution process for the second frequency component, thereby to generate an integrated information; and an output unit that outputs the integrated information.

An information processing method according to an example aspect of this disclosure includes: inputting a feature quantity; performing a discrete wavelet transform on the feature quantity; decomposing a result of the discrete wavelet transform into a first frequency component and a second frequency component; performing a convolution process on the first frequency component; performing a convolution process on the second frequency component; integrating a result of the convolution process for the first frequency component and a result of the convolution process for the second frequency component, thereby to generate an integrated information; and outputting the integrated information.

A recording medium according to an example aspect of this disclosure is a recording medium on which a computer program is recorded, the computer program operating a computer to: input a feature quantity; perform a discrete wavelet transform on the feature quantity; decompose a result of the discrete wavelet transform into a first frequency component and a second frequency component; perform a convolution process on the first frequency component; perform a convolution process on the second frequency component; integrate a result of the convolution process for the first frequency component and a result of the convolution process for the second frequency component, thereby to generate an integrated information; and output the integrated information.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a conceptual diagram illustrating an example of a discrete wavelet transform by an information processing system according to a second example embodiment.

FIG. 5 is a flowchart illustrating a flow of operation of the information processing system according to the second example embodiment.

FIG. 6 is a block diagram illustrating a functional configuration of an information processing system according to a third example embodiment.

FIG. 7 is a conceptual diagram illustrating an example of information integration by the information processing system according to the third example embodiment.

FIG. 8 is a flowchart illustrating a flow of operation of an information processing system according to a third example embodiment.

FIG. 9 is a block diagram illustrating a functional configuration of an information processing system according to a fourth example embodiment.

FIG. 10 is a flowchart illustrating a flow of operation of the information processing system according to the fourth example embodiment.

FIG. 11 is a conceptual diagram illustrating a method of information integration by an information processing system according to a fifth example embodiment.

FIG. 12 is a conceptual diagram illustrating a method of information integration by an information processing system according to a sixth example embodiment.

FIG. 13 is a conceptual diagram illustrating a method of information integration by an information processing system according to a seventh example embodiment.

FIG. 14 is a block diagram illustrating a functional configuration of an information processing system according to an eighth example embodiment.

FIG. 15 is a block diagram illustrating a functional configuration of an information processing system according to a modified example of the eighth example embodiment.

FIG. 16 is a conceptual diagram illustrating an example of information integration using an attention mechanism by the information processing system according to the eighth example embodiment.

### DESCRIPTION OF EXAMPLE EMBODIMENTS

Hereinafter, an information processing system, an information processing method, a computer program, and a recording medium according to example embodiments will be described with reference to the drawings.

### First Example Embodiment

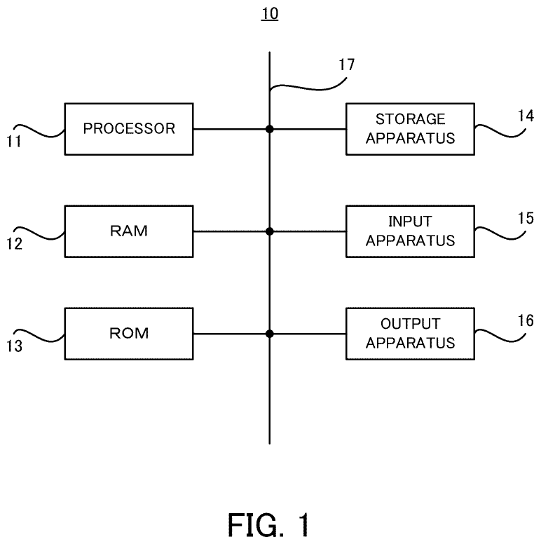

An information processing system according to a first example embodiment will be described with reference to FIG. 1 to FIG. 3.

### (Hardware Configuration)

First, a hardware configuration of an information processing system 10 according to the first example embodiment will be described with reference to FIG. 1. FIG. 1 is a block diagram illustrating the hardware configuration of the information processing system according to the first example embodiment.

As illustrated in FIG. 1, the information processing system 10 according to the first example embodiment includes a processor 11, a RAM (Random Access Memory)l2, a ROM (Read Only Memory)13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for processing an inputted feature quantity is realized or implemented in the processor 11. As the processor 11, one of a CPU (Central Processing Unit), a GPU (Graphics Processing Unit), a FPGA (field-programmable gate array), a DSP (Digital Signal Processor), and an ASIC (Application Specific Integrated Circuit) may be used, or a plurality of them may be used in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel.

The output apparatus 16 is an apparatus that outputs information about the information processing system10 to the outside. For example, the output apparatus 16 may be a display apparatus (e.g., a display) that is configured to display the information about the information processing system 10.

### (Functional Configuration)

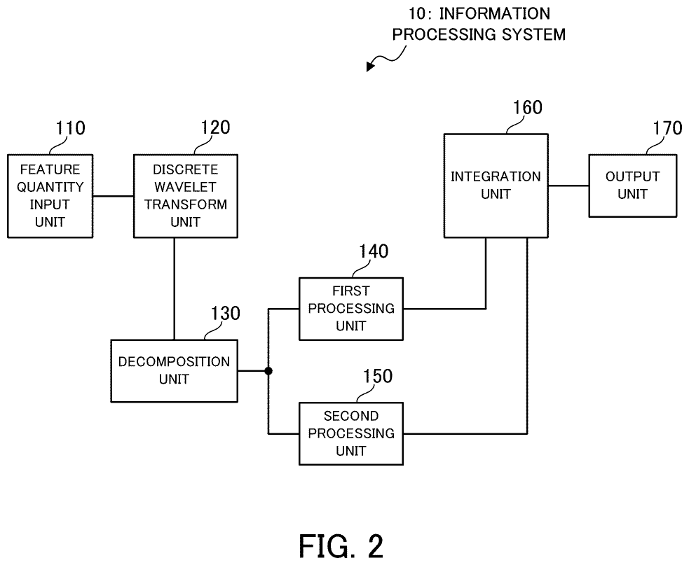

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment includes, as processing blocks for realizing the functions thereof, a feature quantity input unit 110, a discrete wavelet transform unit 120, a decomposition unit 130, a first processing unit 140, a second processing unit 150, an integration unit 160, and an output unit 170. Each of the feature quantity input unit 110, the discrete wavelet transform unit 120, the decomposition unit 130, the first processing unit 140, the second processing unit 150, the integration unit 160, and the output unit 170 may be realized or implemented in the processor 11, for example. More specifically, it may be configured as a part of a neural network.

The feature quantity input unit 110 is configured to input a feature quantity. In other words, the feature quantity input unit 110 is configured to obtain the feature quantity. The feature quantity may be a feature quantity extracted from an image, for example. More specifically, the feature quantity may be a feature quantity corresponding to a particular part (e.g., a face or an eye) of a living body included in an image

The discrete wavelet transform unit 120 is configured to perform a discrete wavelet transform on the feature quantity inputted by the feature quantity input unit 110. A detailed description of the discrete wavelet transform will be omitted herein, because the existing techniques/technologies can be adopted thereto, as appropriate.

The decomposition unit 130 is configured to decompose a result of the discrete wavelet transform (i.e., information obtained by transforming the feature quantity) into a first frequency component and a second frequency component. Frequency bands of the first frequency component and the second frequency component may be set in advance.

The first processing unit 140 is configured to perform a convolution process on the first frequency component obtained by the decomposition by the decomposition unit 130. The first processing unit 140 may perform the convolution process on the first frequency component only once, or may perform the convolution process more than once. In addition, after the convolution process, the first processing unit 140 may perform a process such as the action of a nonlinear function and normalization. These processes (i.e., the action of a nonlinear function, normalization, etc.) may be performed after all the convolution processes described later.

The second processing unit 150 is configured to perform a convolution process on the second frequency component obtained by the decomposition by the decomposition unit 130. The second processing unit 150 may perform the convolution process on the second frequency component only once, or may perform the convolution process more than once.

In the above-described configuration, the first processing unit 140 performs the convolution process on the first frequency component, and the second processing unit 150 performs the convolution process on the second frequency component, but these processes may be performed by one processing unit. Specifically, one processing unit that integrates the functions of the first processing unit 140 and the second processing unit 150 may be configured to perform each of the convolution process for the first frequency component and the convolution process for the second frequency component.

The integration unit 160 is configured to integrate a result of the convolution process of the first processing unit 140 (i.e., a result of the convolution process performed on the first frequency component) and a result of the convolution process of the second processing unit 150 (i.e., a result of the convolution process performed on the second frequency component) to generate an integrated information. An integration method is not particularly limited. A specific example of the integration method will be described in detail in another example embodiment described later.

The output unit 170 is configured to output the integrated information generated by the integration unit 160. The integrated information is outputted as information obtained by performing various processes on the feature quantity inputted by the feature quantity unit 110, as described above. The integrated information may be outputted as information used for deep learning of the neural network.

### (Flow of Operation)

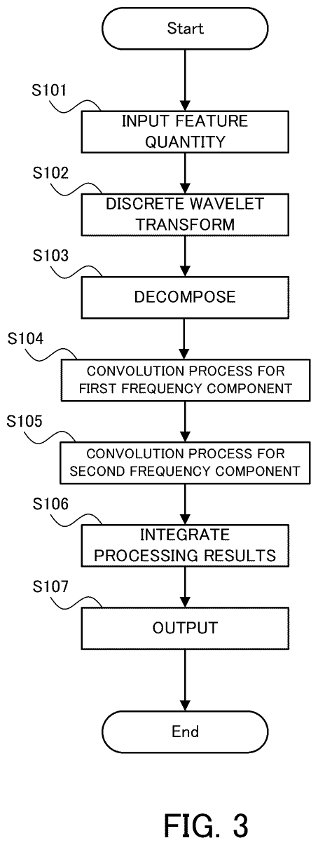

Next, a flow of operation of the information processing system 10 according to the first example embodiment will be described with reference to FIG. 3. FIG. 3 is a flowchart illustrating the flow of the operation of the information processing system according to the first example embodiment.

As illustrated in FIG. 3, in operation of the information processing system 10 according to the first example embodiment, first, the feature quantity input unit 110 inputs the feature quantity (step S101). The inputted feature quantity is outputted to the discrete wavelet transform unit 120. Then, the discrete wavelet transform unit 120 performs the discrete wavelet transform on the inputted feature quantity (step S102). A transform result of the discrete wavelet transform is outputted to the decomposition unit 130.

Subsequently, the decomposition unit 130 decomposes the transform result of the discrete wavelet transform unit 120 into the first frequency component and the second frequency component (step S103). The first frequency component is outputted to the first processing unit 140. The second frequency component is outputted to the second processing unit 150.

Subsequently, the first processing unit 140 performs the convolution process on the first frequency component (step S104). In addition, the second processing unit 150 performs the convolution process on the second frequency component (step S105). The steps S104 and S105 may be performed in an arbitrary order, or may be performed in parallel simultaneously. Each of processing results of the first processing unit 140 and the second processing unit 150 is outputted to the integration unit 160.

Subsequently, the integration unit 160 integrates the processing result of the first processing unit 140 and the processing result of the second processing unit 150, thereby to generate the integrated information (step S106). Then, the output unit 170 outputs the integrated information generated by the integration unit 160 (step S107).

### (Technical Effect)

Next, a technical effect obtained by the information processing system 10 according to the first example embodiment will be described.

As described in FIG. 1 to FIG. 3, in the information processing system 10 according to the first example embodiment, the convolution process is performed on each of the first frequency component and the second frequency component obtained by the discrete wavelet transform, and then, these components are integrated and outputted as the integrated information. In this way, each of the first frequency component and the second frequency component is held, and it is thus possible to output more accurate information than information when downsampling is simply performed, for example. Furthermore, since the integration is performed after the convolution process is separately performed on the first frequency component and the second frequency component, it is possible to obtain a high-quality output (an intermediate feature quantity) while suppressing an increase in memory cost, as compared with when a normal convolution process is performed. Such a technical effect is remarkably exhibited by a use in a layer close to an input of a DNN (Deep Neural Network) (e.g., when the same channel number of convolution processes are applied to an original resolution, the memory cost can be reduced to ¼).

### Second Example Embodiment

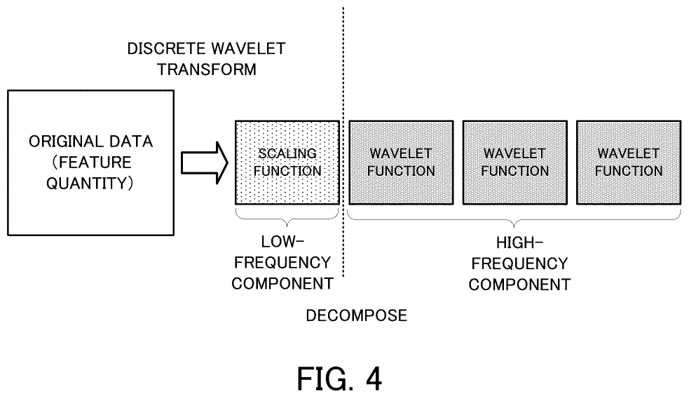

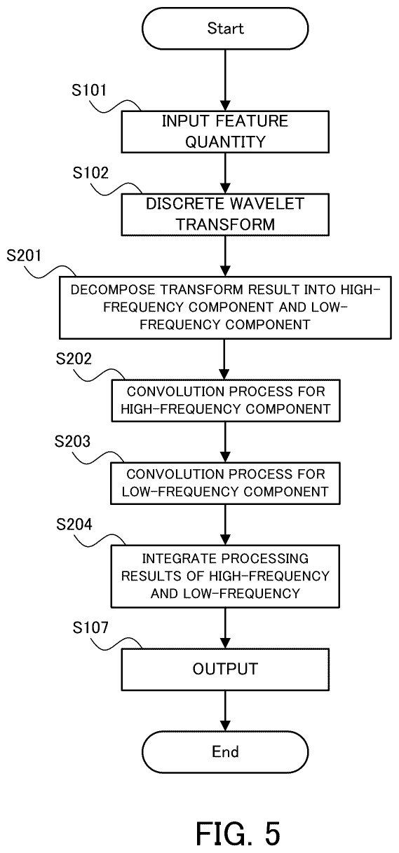

The information processing system 10 according to a second example embodiment will be described with reference to FIG. 4 and FIG. 5. The second example embodiment is partially different from the first example embodiment only in the operation, and may be the same as the first example embodiment in the configuration or the like (see FIG. 1 and FIG. 2). For this reason, a description of a part that overlaps the first example embodiment will be omitted below.

### (Discrete Wavelet Transform)

First, the discrete wavelet transform by the information processing system 10 according to the second example embodiment will be specifically described with reference to FIG. 4. FIG. 4 is a conceptual diagram illustrating an example of the discrete wavelet transform by the information processing system according to the second example embodiment.

As illustrated in FIG. 4, the information processing system 10 according to the second example embodiment decomposes the result of the discrete wavelet transform of original data (i.e., the feature quantity inputted by the feature quantity input unit 110) into a high-frequency component (corresponding to the first frequency component in the first example embodiment) and a low-frequency component (corresponding to the second frequency component in the first example embodiment). The high-frequency component may be, for example, a wavelet function. The low-frequency component may be, for example, a scaling function.

### (Flow of Operation)

Next, a flow of operation of the information processing system 10 according to the second example embodiment will be described with reference to FIG. 5. FIG. 5 is a flowchart illustrating the flow of the operation of the information processing system according to the second example embodiment. In FIG. 5, the same steps as those illustrated in FIG. 3 carry the same reference numerals.

As illustrated in FIG. 5, in operation of the information processing system 10 according to the second example embodiment, first, the feature quantity input unit 110 inputs the feature quantity (step S101). Then, the discrete wavelet transform unit 120 performs the discrete wavelet transform on the inputted feature quantity (step S102).

Subsequently, the decomposition unit 130 decomposes the transformation result of the discrete wavelet transform unit 120 into the high-frequency component and the low-frequency component (step S201). The high-frequency component is outputted to the first processing unit 140. The low-frequency component is outputted to the second processing unit 150.

Subsequently, the first processing unit 140 performs the convolution process on the high-frequency component (step S202). In addition, the second processing unit 150 performs the convolution process on the low-frequency component (step S203). The steps S202 and S203 may be performed in an arbitrary order, or may be performed in parallel simultaneously.

Subsequently, the integration unit 160 integrates the processing result of the first processing unit 140 (i.e., the processing result for the high-frequency component) and the processing result of the second processing unit 150 (i.e., the processing result for the low-frequency component), thereby to generate the integrated information (step S204). Then, the output unit 170 outputs the integrated information generated by the integration unit 160 (step S107).

### (Technical Effect)

Next, a technical effect obtained by the information processing system 10 according to the second example embodiment will be described.

As described in FIG. 4 and FIG. 5, in the information processing system 10 according to the second example embodiment, the result of the discrete wavelet transform is decomposed into the high-frequency component and the low-frequency component, the convolution process is performed on each of the components, and then, the integration is performed. In this way, the high-frequency component indicating a low-level feature quantity of an image is held, and it is thus possible to output more accurate information than information when the high-frequency component is cut, for example. Furthermore, since the integration is performed after the convolution process is separately performed on the high-frequency component and the low-frequency component, it is possible to obtain a high-quality output (an intermediate feature quantity) while suppressing an increase in memory cost. The technical effect according to the second example embodiment is remarkably exhibited in a process in which the low-level feature quantity (e.g., position of an outer corner of an eye, etc.) is important, such as gaze detection.

In the following example embodiment, a description will be given on the premise of the configuration in the second example embodiment (i.e., the configuration in which the result of the discrete wavelet transform is decomposed into the high-frequency component and the low-frequency component).

### Third Example Embodiment

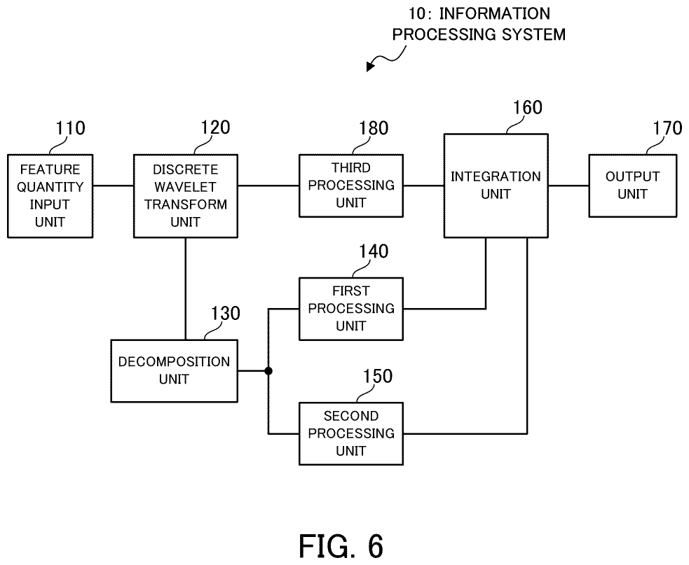

The information processing system 10 according to a third example embodiment will be described with reference to FIG. 6 to FIG. 8. The third example embodiment is partially different from the first and second example embodiments only in the configuration and operation, and may be the same as the first and second example embodiments in the other parts. For this reason, a description of a part that overlaps the example embodiments described above will be omitted below.

### (Functional Configuration)

First, a functional configuration of the information processing system 10 according to the third example embodiment will be described with reference to FIG. 6. FIG. 6 is a block diagram illustrating the functional configuration of the information processing system according to the third example embodiment. In FIG. 6, the same components as those illustrated in FIG. 2 carry the same reference numerals.

As illustrated in FIG. 6, the information processing system 10 according to the third example embodiment includes, as processing blocks for realizing the functions thereof, the feature quantity input unit 110, the discrete wavelet transform unit 120, the decomposition unit 130, the first processing unit 140, the second processing unit 150, the integration unit 160, the output unit 170, and a third processing unit 180. That is, the information processing system 10 according to the third example embodiment further includes the third processing unit 180, in addition to the configuration in the first example embodiment (see FIG. 2).

The third processing unit 180 is configured to perform a convolution process on the result of the discrete wavelet transform. That is, the third processing unit 180 is configured to perform the convolution process on both the high-frequency component (the first frequency component) and the low-frequency component (the second frequency component) before the decomposition by the decomposition unit 130. The third processing unit 180 may perform the convolution process only once, or may perform the convolution process more than once, on the result of the discrete wavelet transform.

An output result of the third processing unit 180 is configured to be outputted to the integration unit 160. The integration unit 160 according to the third example embodiment is configured to integrate the processing result of the first processing unit 140, the processing result of the second processing unit 150, and the processing result of the third processing unit 180.

### (Integration Example)

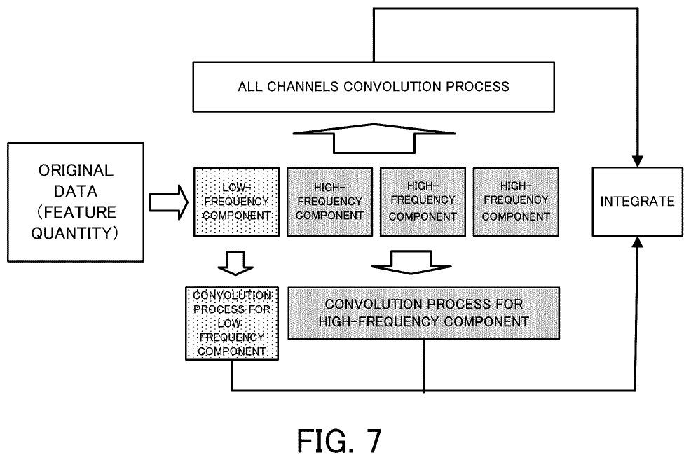

Next, an integration example by the information processing system 10 according to the third example embodiment (i.e., the operation of the integration unit 160) will be described with reference to FIG. 7. FIG. 7 is a conceptual diagram illustrating an example of information integration by the information processing system according to the third example embodiment.

As illustrated in FIG. 7, the convolution process is separately performed on the high-frequency and the low-frequency component obtained from the original data (see downward arrows in the figure). Especially in the third example embodiment, the convolution process is performed, without the decomposition (see an upward arrow in the drawing), on both the high-frequency component and the low-frequency component (all channels). Results of these convolution processes are integrated in the integration unit 160. That is, the result of the convolution process for the high-frequency component, the result of the convolution process for the low-frequency component, and the result of the convolution process for both the high-frequency component and the low-frequency component are integrated. A specific method of integrating these three results will be described in detail in another example embodiment described later.

### (Flow of Operation)

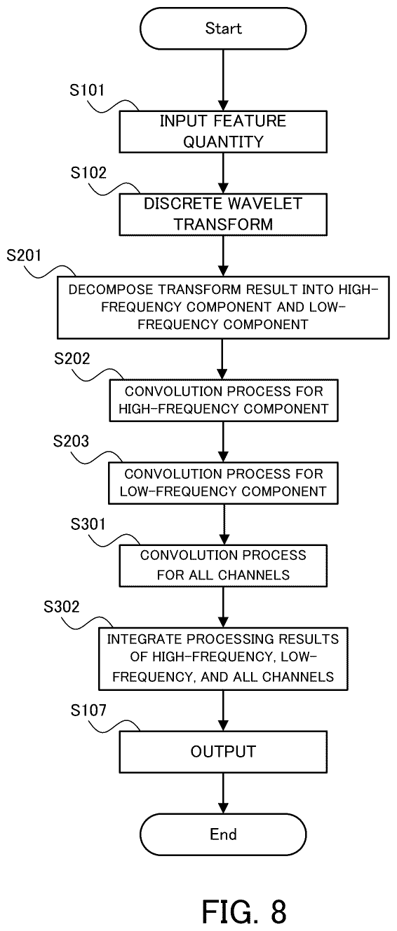

Next, a flow of operation of the information processing system 10 according to the third example embodiment will be described with reference to FIG. 8. FIG. 8 is a flowchart illustrating the flow of the operation of the information processing system according to the third example embodiment. In FIG. 8, the same steps as those illustrated in FIG. 5 carry the same reference numerals.

As illustrated in FIG. 8, in operation of the information processing system 10 according to the third example embodiment, first, the feature quantity input unit 110 inputs the feature quantity (step S101). Then, the discrete wavelet transform unit 120 performs the discrete wavelet transform on the inputted feature quantity (step S102). The result of the discrete wavelet transform is outputted to the third processing unit 180 in addition to the decomposition unit 130.

Subsequently, the decomposition unit 130 decomposes the transformation result of the discrete wavelet transform unit 120 into the high-frequency component and the low-frequency component (step S201). The high-frequency component is outputted to the first processing unit 140. The low-frequency component is outputted to the second processing unit 150.

Subsequently, the first processing unit 140 performs the convolution process on the high-frequency component (step S202). In addition, the second processing unit 150 performs the convolution process on the low-frequency component (step S203). Furthermore, the third processing unit 180 performs the convolution process on the transform result of the discrete wavelet transform unit 120 (step S301). The steps 5202, 5203, and 5301 may be performed in an arbitrary order, or may be performed in parallel simultaneously.

Subsequently, the integration unit 160 integrates the processing result of the first processing unit 140 (i.e., the processing result for the high-frequency component), the processing result of the second processing unit 150 (i.e., the processing result for the low-frequency component), and the processing result of the third processing unit 180 (i.e., the processing result for all the channels), thereby to generate the integrated information (step S302). Then, the output unit 170 outputs the integrated information generated by the integration unit 160 (step S107).

### (Technical Effect)

Next, a technical effect obtained by the information processing system 10 according to the third example embodiment will be described.

As described in FIG. 6 to FIG. 8, in the information processing system 10 according to the third example embodiment, the results of the convolution process performed separately on the high-frequency component and the low-frequency component, and the result of the convolution process performed on both the high-frequency component and the low-frequency component (i.e., before the decomposition) are integrated. In this way, it is possible to efficiently incorporate an interaction between the high-frequency component and the low-frequency component in the integration. Specifically, the interaction between the high-frequency component and the low-frequency component included int the processing result of the third processing unit 180 can be used for more appropriate integration. Consequently, it is possible to reduce a burden on the integration unit 160, and for example, it is possible to easily perform the learning of the neural network.

In the following example embodiment, a description will be given on the premise of the configuration in the third example embodiment (i.e., the configuration in which the processing results of the first processing unit 140, the second processing unit 150, and the third processing unit 180 are integrated).

### Fourth Example Embodiment

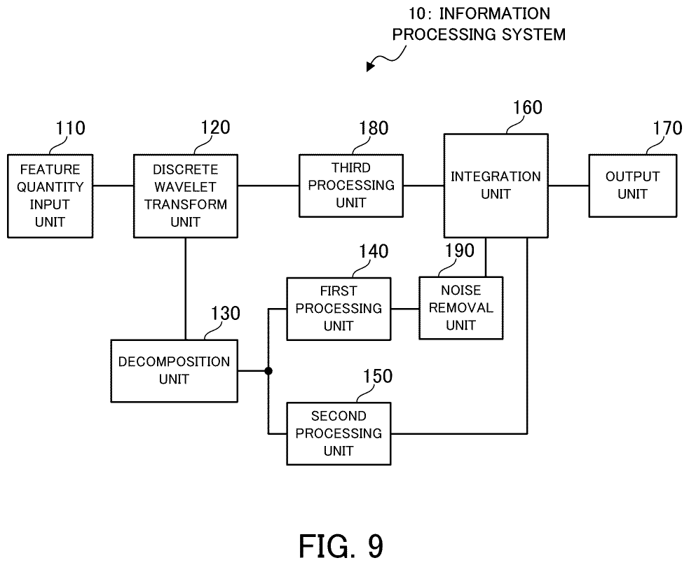

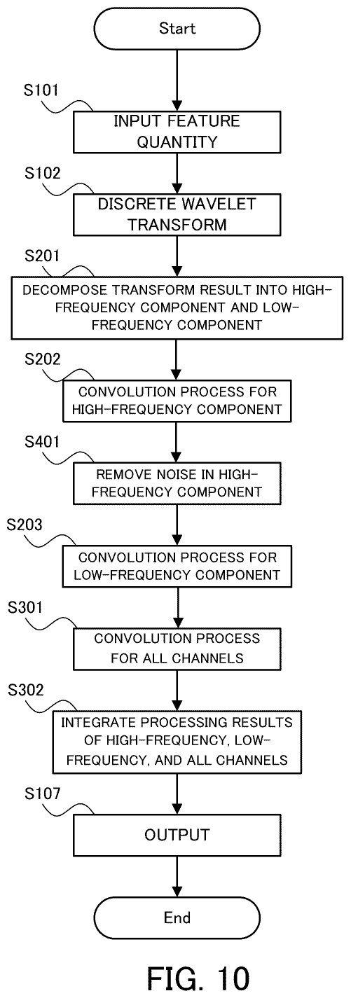

The information processing system 10 according to a fourth example embodiment will be described with reference to FIG. 9 and FIG. 10. The fourth example embodiment is partially different from the first to third example embodiments only in the configuration and operation, and may be the same as the first to third example embodiments in the other parts. For this reason, a description of a part that overlaps the example embodiments described above will be omitted below.

### (Functional Configuration)

First, a functional configuration of the information processing system 10 according to the fourth example embodiment will be described with reference to FIG. 9. FIG. 9 is a block diagram illustrating the functional configuration of the information processing system according to the fourth example embodiment. In FIG. 9, the same components as those illustrated in FIG. 6 carry the same reference numerals.

As illustrated in FIG. 9, the information processing system 10 according to the fourth example embodiment includes, as processing blocks for realizing the functions thereof, the feature quantity input unit 110, the discrete wavelet transform unit 120, the decomposition unit 130, the first processing unit 140, the second processing unit 150, the integration unit 160, the output unit 170, the third processing unit 180, and a noise removal unit 190. That is, the information processing system 10 according to the fourth example embodiment further includes the noise removal unit 190, in addition to the configuration in the third example embodiment (see FIG. 6).

The noise removal unit 190 is configured to remove a partial component from the result of the convolution process for the high-frequency component. Specifically, the noise removal unit 190 is configured to be able to remove a high-frequency component corresponding to a noise (i.e., a high-frequency component of the high-frequency component) from the result of the convolution process for the high-frequency component. The noise removal unit 190 further performs the discrete wavelet transform or a Fourier transform on the result of the convolution process for the high-frequency component, thereby to remove the high-frequency component of the result, for example. Alternatively, the noise removal unit 190 may remove the high-frequency component, by applying a low-pass filter to the result of the convolution process for the high-frequency component, for example.

### (Flow of Operation)

Next, a flow of operation of the information processing system 10 according to the fourth example embodiment will be described with reference to FIG. 10. FIG. 10 is a flowchart illustrating the flow of the operation of the information processing system according to the fourth example embodiment. In FIG. 10, the same steps as those illustrated in FIG. 8 carry the same reference numerals.

As illustrated in FIG. 10, in operation the information processing system 10 according to the fourth example embodiment, first, the feature quantity input unit 110 inputs the feature quantity (step S101). Then, the discrete wavelet transform unit 120 performs the discrete wavelet transform on the inputted feature quantity (step S102).

Subsequently, the decomposition unit 130 decomposes the transformation result of the discrete wavelet transform unit 120 into the high-frequency component and the low-frequency component (step S201). The high-frequency component is outputted to the first processing unit 140. The low-frequency component is outputted to the second processing unit 150.

Subsequently, the first processing unit 140 performs the convolution process on the high-frequency component (step S202). Especially in the fourth example embodiment, the result of the convolution process performed on the high-frequency component is outputted to the noise removal unit 190. The noise removal unit 190 removes the noise component from the result of the convolution process for the high-frequency component (step S401).

On the other hand, the second processing unit 150 performs the convolution process on the low-frequency component (step S203). Furthermore, the third processing unit 180 performs the convolution process on the transform result of the discrete wavelet transform unit 120 (step S301).

Subsequently, the integration unit 160 integrates the processing result for the high-frequency component (i.e., excluding the noise), the processing result for the low-frequency component, and the processing result for all the channels, thereby to generate the integrated information (step S302). Then, the output unit 170 outputs the integrated information generated by the integration unit 160 (step S107).

### (Technical Effect)

Next, a technical effect obtained by the information processing system 10 according to the fourth example embodiment will be described.

As described in FIG. 8 and FIG. 9, in the information processing system 10 according to the fourth example embodiment, the partial component (the noise component) of the high-frequency component is removed. In this way, since the noise included in the high-frequency component may be reduced, it is possible to increase robustness and ruggedness against vulnerability attack (so-called Adversarial Attack), or the like, for example.

### Fifth Example Embodiment

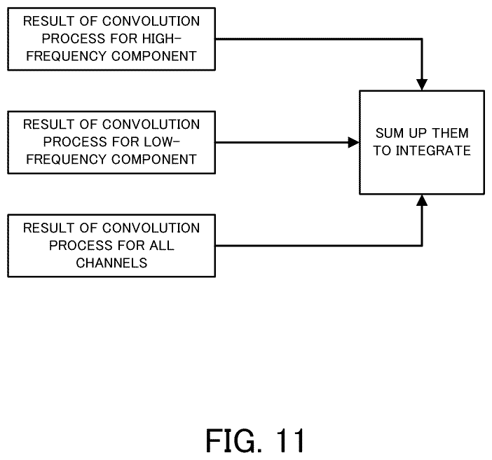

The information processing system 10 according to a fifth example embodiment will be described with reference to FIG. 11. The fifth example embodiment describes an example of the integration method that is applicable to the first to fourth example embodiments, and may be the same as the first to fourth example embodiments in the configuration and operation. For this reason, a description of a part that overlaps the example embodiments described above will be omitted below.

### (Integration Example)

First, the integration method by the information processing system 10 according to the fifth example embodiment will be described with reference to FIG. 11. FIG. 11 is a conceptual diagram illustrating a method of information integration by the information processing system according to the fifth example embodiment.

As illustrated in FIG. 11, the integration unit 160 according to the fifth example embodiment sums up the result of the convolution process for the high-frequency component (i.e., the processing result of the first processing unit 140), the result of the convolution process of the low-frequency component (i.e., the processing result of the second processing unit 150), and the result of the convolution process for all the channels (i.e., the processing result of the third processing unit 180), thereby to integrate.

For example, the integration unit 160 may integrate the result of the convolution process for all the channels as “Conv(all)”, the result of the convolution process for the high-frequency component as “Conv(high)”, and the result of the convolution process for the low-frequency component as “Conv(low)”, by using the following equation (1).

Conv(all)+C1×Conv(high)+C2×Conv(low) (1)

C1 and C2 are predetermined coefficients and may be set in advance. Here, Conv(high) and Conv(low) are multiplied by the respective coefficients, but only one of Conv(high) and Conv(low) may be multiplied by the corresponding coefficient. Conv(all) may also be multiplied by a coefficient.

### (Technical Effect)

Next, a technical effect obtained by the information processing system 10 according to the fifth example embodiment will be described.

As illustrated in FIG. 11, in the information processing system 10 according to the fifth example embodiment, the integrated information is generated by summing up the results of the respective convolution processes. In this way, it is possible to generate the integrated information, relatively easily. The above-described example embodiment exemplifies that the results of the convolution process for all the channels are integrated (i.e., the three processing results are integrated). When the result of the convolution process for the high-frequency component and the result of the convolution process for the low-frequency component (i.e., the two processing results are integrated) are integrated, the two results may be summed up to integrate.

### Sixth Example Embodiment

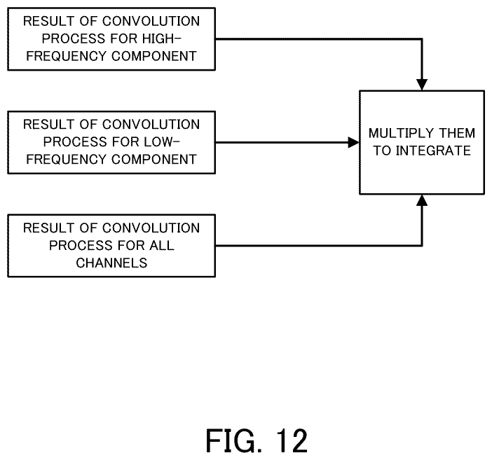

The information processing system 10 according to a sixth example embodiment will be described with reference to FIG. 12. The sixth example embodiment describes an example of the integration method that is applicable to the first to fourth example embodiments, as in the fifth example embodiment described above, and may be the same as the first to fourth example embodiments in the configuration and operation. For this reason, a description of a part that overlaps the example embodiments described above will be omitted below.

### (Integration Example)

First, the integration method by the information processing system 10 according to the sixth example embodiment will be described with reference to FIG. 12. FIG. 12 is a conceptual diagram illustrating a method of information integration by the information processing system according to the sixth example embodiment.

As illustrated in FIG. 12, the integration unit 160 according to the sixth example embodiment multiplies the result of the convolution process for the high-frequency component (i.e., the processing result of the first processing unit 140), the result of the convolution process for the low-frequency component (i.e., the processing result of the second processing unit 150), and the result of the convolution process for all the channels (i.e., the processing result of the third processing unit 180), thereby to integrate.

For example, the integration unit 160 may integrate the results by using the following equation (2).

Conv(all)×Conv(high)+Conv(low) (2)

### (Technical Effect)

Next, a technical effect obtained by the information processing system 10 according to the sixth example embodiment will be described.

As illustrated in FIG. 12, in the information processing system 10 according to the sixth example embodiment, the integrated information is generated by multiplying the results of the respective convolution processes. In this way, it is possible to generate the integrated information, relatively easily. The above-described example embodiment exemplifies that the results of the convolution process for all the channels are integrated (i.e., the three processing results are integrated). When the result of the convolution process for the high-frequency component and the result of the convolution process for the low-frequency component (i.e., the two processing results are integrated) are integrated, the two results may be multiplied to integrate.

### Seventh Example Embodiment

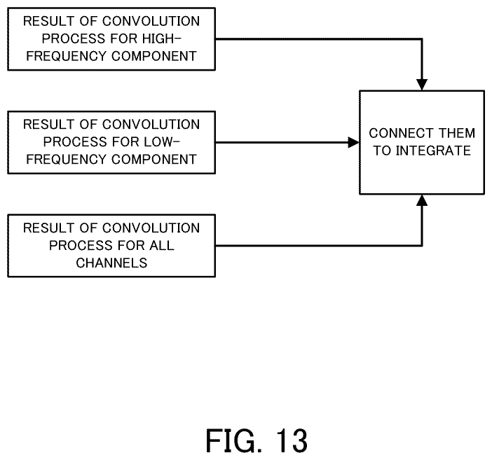

The information processing system 10 according to a seventh example embodiment will be described with reference to FIG. 13. The seventh example embodiment describes an example of the integration method that is applicable to the first to fourth example embodiments, as in the fifth and sixth forms described above, and may be the same as the first to fourth example embodiments in the configuration and operation. For this reason, a description of a part that overlaps the example embodiments described above will be omitted below.

### (Integration Example)

First, the integration method by the information processing system 10 according to the seventh example embodiment will be described with reference to FIG. 13. FIG. 13 is a conceptual diagram illustrating a method of information integration by the information processing system according to the seventh example embodiment.

As illustrated in FIG. 13, the integration unit 160 according to the seventh example embodiment connects the result of the convolution process for the high-frequency component (i.e., the processing result of the first processing unit 140), the result of the convolution process for the low-frequency component (i.e., the processing result of the second processing unit 150), and the result of the convolution process for all the channels (i.e., the processing result of the third processing unit 180), thereby to integrate.

For example, the integration unit 160 may connect the results of the respective convolution processes in a channel direction, like [Conv(all), Conv(high), and Conv(low], for example.

### (Technical Effect)

Next, a technical effect obtained by the information processing system 10 according to the seventh example embodiment will be described.

As illustrated in FIG. 13, in the information processing system 10 according to the seventh example embodiment, the integrated information is generated by connecting the results of the respective convolution processes. In this way, it is possible to generate the integrated information, relatively easily. The above-described example embodiment exemplifies that the results of the convolution process for all the channels are integrated (i.e., the three processing results are integrated). When the result of the convolution process for the high-frequency component and the result of the convolution process for the low-frequency component (i.e., the two processing results are integrated) are integrated, the two results may be connected to integrate.

### Eighth Example Embodiment

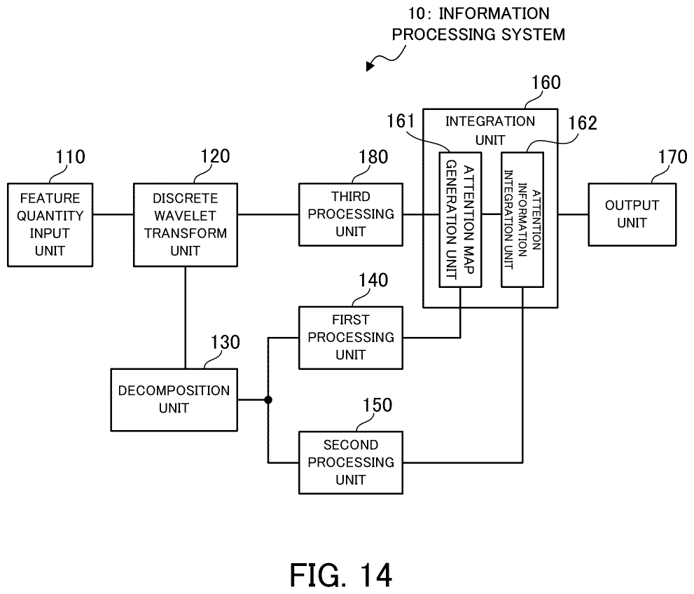

The information processing system 10 according to an eighth example embodiment will be described with reference to FIG. 14 to FIG. 16. The information processing system 10 according to the eighth example embodiment describes an example of the integration method that is applicable to the first to fourth example embodiments, as in the fifth to seventh example embodiments, and may be the same as the first to fourth example embodiments in the main configuration and operation. For this reason, a description of a part that overlaps the example embodiments described above will be omitted below.

### (Functional Configuration)

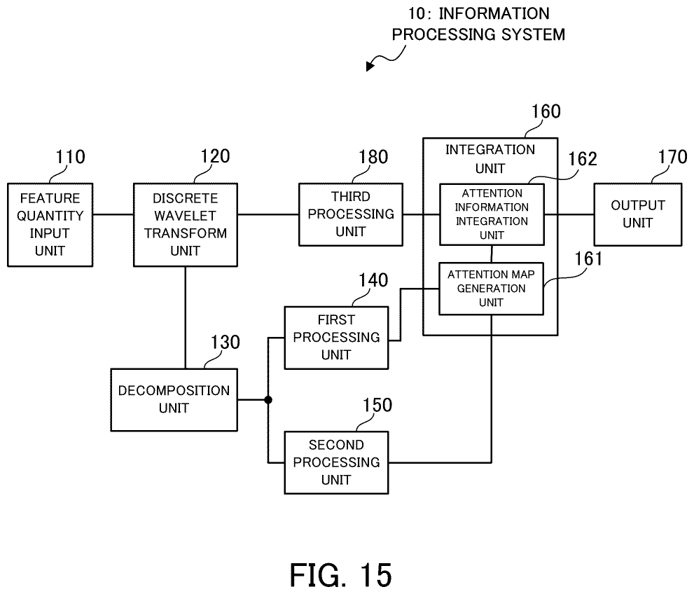

First, a functional configuration of the information processing system 10 according to the eighth example embodiment will be described with reference to FIG. 14 and FIG. 15. FIG. 14 is a block diagram illustrating the functional configuration of the information processing system according to the eighth example embodiment. FIG. 15 is a block diagram illustrating a functional configuration of an information processing system according to a modified example of the eighth example embodiment. In FIG. 14 and FIG. 15, the same components as those illustrated in FIG. 6 carry the same reference numerals.

As illustrated in FIG. 14, the information processing system 10 according to the eighth example embodiment includes, as processing blocks for realizing the functions thereof, the feature quantity input unit 110, the discrete wavelet transform unit 120, the decomposition unit 130, the first processing unit 140, the second processing unit 150, the integration unit 160, the output unit 170, and the third processing unit 180. In particular, the integration unit 160 according to the eighth example embodiment includes an attention map generation unit 161 and an attention information integration unit 162.

The attention map generation unit 161 is configured to generate an attention map (an important part) on the basis of the result of the first processing unit 140 (i.e., the result of the convolution process for the high-frequency component) and the result of the third processing unit 180 (i.e., the result of the convolution process for all the channels). The attention map generated by the attention map generation unit 161 is configured to be outputted to the attention information integration unit 162.

The attention information integration unit 162 is configured to generate the integrated information on the basis of the attention map generated by the attention map generation unit 161 and the result of the second processing unit 150 (i.e., the result of the convolution process for the low-frequency component). The integrated information generated by the attention map information integration unit 162 is configured to be outputted to the output unit 170.

As illustrated in FIG. 15, the attention map generation unit 161 according to the modified example of the eighth example embodiment may be configured to generate the attention map (the important part) on the basis of the result of the first processing unit 140 (i.e., the result of the convolution process for the high-frequency component) and the result of the second processing unit 150 (i.e., the result of the convolution process for the low-frequency component). In this case, the attention information integration unit 162 may be configured to generate the integrated information on the basis of the attention map generated by the attention map generation unit 161 and the result of the third processing unit 180 (i.e., the result of the convolution process for all the channels). The configurations of the attention map generation unit 161 and the attention information integration unit 162 are not limited to the examples in FIG. 14 and FIG. 15.

### (Operation of Attention Mechanism)

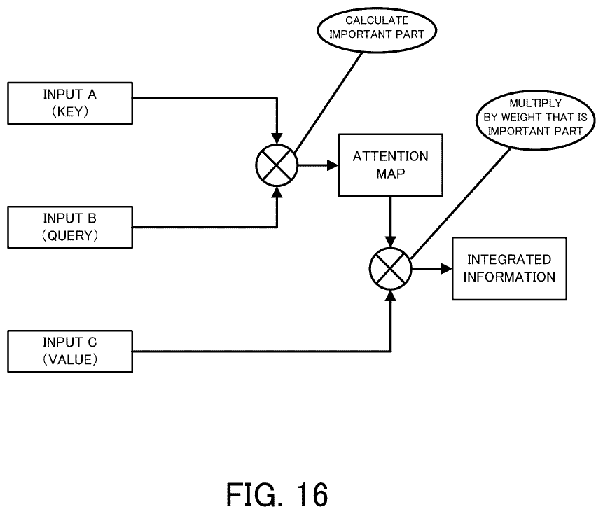

Next, with reference to FIG. 16, operation of an attention mechanism according to the eighth example embodiment (i.e., the integration unit 160) will be described. FIG. 16 is a conceptual diagram illustrating an example of information integration using the attention mechanism by the information processing system according to the eighth example embodiment.

As illustrated in FIG. 16, an input A (key), an input B (query), and an input C (value) are inputted to the integration unit 160 according to the eighth example embodiment.

In operation of integration unit 160, first, the attention map generation unit 161 generates the attention map by calculating a matrix product of the input A and the input B. At this time, as described in FIG. 14, the input A and the input B are the processing result of the first processing unit 140 and the processing result of the third processing unit 180 (i.e., a combination of Conv(high) and Conv(a11)). The input A and the input B, however, may be another combination. Specifically, as described in FIG. 15, the input A and the input B may be the processing result of the first processing unit 140 and the processing result of the second processing unit 150 (i.e., a combination of Conv(high) and Conv(low)). Although it is not illustrated, the input A and the input B may be the processing result of the second processing unit 150 and the processing result of the third processing unit 180 (i.e., a combination of Conv(low) and Conv(all)), or both may be the processing result of the third processing unit 180 (i.e., a combination of Conv(all) and Conv(all)).

Subsequently, the attention information integration unit 162 generates the integrated information by calculating a determinant of the attention map and the processing result of the second processing unit 150 (specifically, by multiplying the processing result of the second processing unit 150 by a weight that is the important part calculated as the attention map).

### (Technical Effect)

Next, a technical effect obtained by the information processing system 10 according to the eighth example embodiment will be described.

As described in FIG. 14 to FIG. 16, in the information processing system 10 according to the eighth example embodiment, the results of the respective convolution processes are integrated by using the attention mechanism. In this way, it is possible to generate the integrated information while holding the important part in the feature quantity.

A processing method in which a program for operating the configuration in each of the example embodiments to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes process alone, but also the program that operates on an OS and executes process in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An information processing system, an information processing method, a computer program, and a recording medium with such changes are also intended to be within the technical scope of this disclosure.

### Supplementary Notes

The example embodiments described above may be further described as, but not limited to, the following Supplementary Notes.

### (Supplementary Note 1)

An information processing system according to Supplementary Note 1 is an information processing system including: an input unit that inputs a feature quantity; a transform unit that performs a discrete wavelet transform on the feature quantity; a decomposition unit that decomposes a result of the discrete wavelet transform into a first frequency component and a second frequency component; a first processing unit that performs a convolution process on the first frequency component; a second processing unit that performs a convolution process on the second frequency component; an integration unit that integrates a result of the convolution process for the first frequency component and a result of the convolution process for the second frequency component, thereby to generate an integrated information; and an output unit that outputs the integrated information.

### (Supplementary Note 2)

An information processing system according to Supplementary Note 2 is the information processing system according to Supplementary Note 1, wherein the first frequency component is a high-frequency component with a frequency that is higher than a predetermined threshold, and the second frequency component is a low-frequency component with a frequency that is lower than the predetermined threshold.

### (Supplementary Note 3)

An information processing system according to Supplementary Note 3 is the information processing system according to Supplementary Note 1 or 2, further including a third processing unit that performs a convolution process on the result of the discrete wavelet transform, wherein the integration unit integrates the result of the convolution process for the first frequency component, the result of the convolution process for the second frequency component, and a result of the convolution process for the result of the discrete wavelet transform.

### (Supplementary Note 4)

An information processing system according to Supplementary Note 4 is the information processing system according to any one of Supplementary Notes 1 to 3, further including a removal unit that removes a partial component from the result of the convolution process for the first frequency component, wherein the integration unit integrates the result of the convolution process for the first frequency component from which the partial component is removed and the result of the convolution process for the second frequency component.

### (Supplementary Note 5)

An information processing system according to Supplementary Note 5 is the information processing system according to any one of Supplementary Notes 1 to 4, wherein the integration unit generates the integrated information by summing up the results of the respective convolution processes.

### (Supplementary Note 6)

An information processing system according to Supplementary Note 6 is the information processing system according to any one of Supplementary Notes 1 to 4, wherein the integration unit generates the integrated information by multiplying the results of the respective convolution processes.

### (Supplementary Note 7)

An information processing system according to Supplementary Note 7 is the information processing system according to any one of Supplementary Notes 1 to 4, wherein the integration unit generates the integrated information by connecting the results of the respective convolution processes.

### (Supplementary Note 8)

An information processing system according to Supplementary Note 8 is the information processing system according to any one of Supplementary Notes 1 to 4, wherein the integration unit generates the integrated information by integrating the results of the respective convolution process with an attention mechanism.

### (Supplementary Note 9)

An information processing method according to Supplementary Note 9 is an information processing method including: inputting a feature quantity; performing a discrete wavelet transform on the feature quantity; decomposing a result of the discrete wavelet transform into a first frequency component and a second frequency component; performing a convolution process on the first frequency component; performing a convolution process on the second frequency component; integrating a result of the convolution process for the first frequency component and a result of the convolution process for the second frequency component, thereby to generate an integrated information; and outputting the integrated information.

### (Supplementary Note 10)

A computer program according to Supplementary Note 10 is a computer program that operates a computer to: input a feature quantity; perform a discrete wavelet transform on the feature quantity; decompose a result of the discrete wavelet transform into a first frequency component and a second frequency component; perform a convolution process on the first frequency component; perform a convolution process on the second frequency component; integrate a result of the convolution process for the first frequency component and a result of the convolution process for the second frequency component, thereby to generate an integrated information; and output the integrated information.

### (Supplementary Note 11)

A recording medium according to Supplementary Note 11 is a recording medium on which the computer program according to Supplementary Note 10 is recorded.

To the extent permitted by law, this application claims priority based on Japanese application No. 2021-057842, filed Mar. 30, 2021, the entire disclosure of which is hereby incorporated by reference. Furthermore, to the extent permitted by law, all publications and papers described herein are incorporated by reference herein.

### DESCRIPTION OF REFERENCE CODES

10 Information processing system
11 Processor
110 Feature quantity input unit
120 Discrete wavelet transform unit
130 Disassembly unit
140 First processing unit
150 Second processing unit
160 Integration unit
161 Attention map generation unit
162 Attention information integration unit
170 Output unit
180 Third processing unit
190 Noise removal unit

What is claimed is:

1. An information processing system comprising:
at least one memory that is configured to store instructions; and
at least one processor that is configured to execute the instructions to
input a feature quantity;
perform a discrete wavelet transform on the feature quantity;
decompose a result of the discrete wavelet transform into a first frequency component and a second frequency component;
perform a convolution process on the first frequency component;
perform a convolution process on the second frequency component;
integrate a result of the convolution process for the first frequency component and a result of the convolution process for the second frequency component, thereby to generate an integrated information; and
output the integrated information.

2. The information processing system according to claim 1, wherein
the first frequency component is a high-frequency component with a frequency that is higher than a predetermined threshold, and
the second frequency component is a low-frequency component with a frequency that is lower than the predetermined threshold.

3. The information processing system according to claim 1, wherein the at least one processor is configured to execute the instructions to
perform a convolution process on the result of the discrete wavelet transform, and
integrate the result of the convolution process for the first frequency component, the result of the convolution process for the second frequency component, and a result of the convolution process for the result of the discrete wavelet transform.

4. The information processing system according to claim 1, wherein the at least one processor is configured to execute the instructions to
remove a partial component from the result of the convolution process for the first frequency component, and
integrate the result of the convolution process for the first frequency component from which the partial component is removed and the result of the convolution process for the second frequency component.

5. The information processing system according to claim 1, wherein the at least one processor is configured to execute the instructions to generate the integrated information by summing up the results of the respective convolution processes.

6. The information processing system according to claim 1, wherein the at least one processor is configured to execute the instructions to generate the integrated information by multiplying the results of the respective convolution processes.

7. The information processing system according to claims 1, wherein the at least one processor is configured to execute the instructions to generate the integrated information by connecting the results of the respective convolution processes.

8. The information processing system according to claim 1, wherein the at least one processor is configured to execute the instructions to generate the integrated information by integrating the results of the respective convolution process with an attention mechanism.

9. An information processing method comprising:
inputting a feature quantity;
performing a discrete wavelet transform on the feature quantity;
decomposing a result of the discrete wavelet transform into a first frequency component and a second frequency component;
performing a convolution process on the first frequency component;
performing a convolution process on the second frequency component;
integrating a result of the convolution process for the first frequency component and a result of the convolution process for the second frequency component, thereby to generate an integrated information; and
outputting the integrated information.

10. A non-transitory recording medium on which a computer program that allows a computer to execute an information processing method is recorded, the information processing method including:
inputting a feature quantity;
performing a discrete wavelet transform on the feature quantity;
decomposing a result of the discrete wavelet transform into a first frequency component and a second frequency component;
performing a convolution process on the first frequency component;
performing a convolution process on the second frequency component;
integrating a result of the convolution process for the first frequency component and a result of the convolution process for the second frequency component, thereby to generate an integrated information; and
outputting the integrated information.
